(19) United States
(12) Patent Application Publication
(10) Pub. No.: US 2025/0276877 A1
(43) Pub. Date: Sep. 4, 2025

(54) Control circuitry for a crane, crane, winch arrangement for a crane, remote control unit for a crane and method to operate a crane

(71) Applicant: Palfinger AG, Bergheim bei Salzburg (AT)

(72) Inventors: Andreas TIEFENTHALER, St. Lorenz (AT); Mario HUFNAGL, Oberndorf bei Salzburg (AT); David GFRERER, Kaprun (AT); Stephan FORSTENPOINTNER, St. Johann am Walde (AT); Daniel EIDENHAMMER, Seekirchen am Wallersee (AT)

(21) Appl. No.: 18/592,842

(22) Filed: Mar. 1, 2024

(51) Int. Cl. B66C 13/40; B66C 13/46; B66C 23/16

(52) U.S. Cl. CPC B66C 13/40; B66C 13/46; B66C 23/166

(57) ABSTRACT

Control circuitry (110) for a crane (120), comprising an input interface (102) configured to receive readings of sensors sensing operating parameters of the crane (120) and an output interface (104) to output control data to cause actuators of the crane (120) to cause a motion of at least one of a boom (130) of a boom system or a column (160) of the crane (120). A compute circuit (106) is configured to control the operation of a winch arrangement (140, 400) mounted to a boom (130) of the boom system, wherein a position of an attachment reference (150) of a cable (420) of the winch arrangement (140, 400) moves along a defined path during movement of the crane (120).

FIG. 1

### FIELD

The present disclosure relates to control of cranes and to control of loads moved be cranes.

### BACKGROUND

Operation of conventional cranes requires experienced operators that simultaneously control different actuators of the crane to achieve a smooth movement of a load attached to the crane.

For example, cranes may come with a winch arrangement to lift loads. The cable or wire of the winch is routed over the tip of the boom system of the crane. Hence, if the operator extends the length of the boom by using one of its extension booms, the cable length along the boom increases while the length of the cable between the tip of the boom and the load decreases. When the operator does not simultaneously move the winch to unwind more cable to avoid a mechanical contact between the load and boom tip, damage to the crane or the load or a winch overload situation may occur.

During movement of the crane, it may also be desirable that the load attached to the cable is maintained at the same height or to follow a determined path, for example for security reasons or if the load has to be moved horizontally or along a certain path to be put in place. Conventionally, movements of the crane, such as for example changing the tilt angle of a boom or the length of its extension boom need to be simultaneously compensated by changing the cable length, i.e. by appropriately operating a winch of the crane. Even a minor deviation may create an uncontrolled oscillation of the load block (and the load attached thereto) which may also undesirable because of resultant security concerns in the event of environments having little space to maneuver.

With traditional cranes, it appears almost impossible even for the most experienced operator to provide a smooth synchronized movement between the functions of the boom assembly (e.g. elevation of the main boom, operation of extension booms) and winch movement. For at least one of the previously mentioned reasons there may exist the desire to increase the accuracy of controlling the load while a crane moves.

### BRIEF DESCRIPTION OF THE FIGURES

Some examples of apparatuses and/or methods will be described in the following by way of example only, and with reference to the accompanying figures, in which

FIG. 1 schematically illustrates an example of control circuitry for a crane;

FIG. 2 schematically illustrates operating a crane such that a horizontal position of an attachment reference of a winch arrangement of a crane remains in a determined range;

FIG. 3 schematically illustrates operating a crane such that a distance between the attachment reference and a tip of the boom system remains in a determined range;

FIG. 4 illustrates an example of a winch arrangement;

FIG. 5 illustrates an example of a control panel;

FIG. 6 illustrates an example of a remote control unit; and

FIG. 7 illustrates a flowchart of an example of a method to operate a crane.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

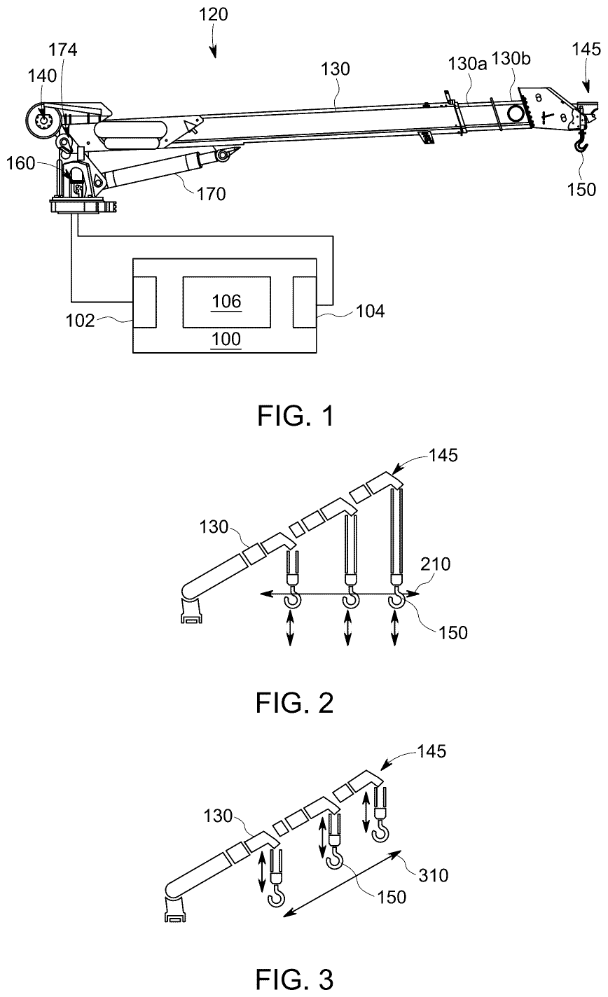

FIG. 1 schematically illustrates an example of control circuitry 100 for a crane together with an exemplary crane 120 having a single boom 130. A winch arrangement 140 is mounted at the crane and the cable of the winch arrangement 140 is routed over a tip 145 of the boom 130.

Generally speaking, a crane comprises a boom system mounted to a column of the crane. The column is rotatable with respect to a base of the crane. In some examples, the axis of rotation of the column may be a substantially vertical axis. The angle of rotation about the axis of rotation may be referred to as the slew angle or slewing angle.

The base can be configured to mount the crane onto a platform. The platform may be a fixed platform or a mobile platform. Examples of mobile platforms are vehicles such as trucks, lorries or ships. The boom system can be rotated or moved relative to the column about an axis (e.g. a boom axis) that is essentially perpendicular to the axis of the rotation of the column. The angle of the rotation of the boom system about the boom axis may be referred to as an elevation angle.

Hydraulic cylinders may be used as actuators to create the force to cause the rotation or motation of the boom system with respect to the elevation angle. A boom system comprises at least one (or e.g. one or more booms). In the event of a plurality of booms (e.g. more than one boom), the boom attached to the column may be referred to as the main boom or first boom. Additionally, a second boom attached to the main boom may be referred to as a knuckle boom. Any (or each) of the booms of a boom system can optionally comprise one or more extension booms to be driven in or out of the boom using, for example, hydraulic means. A boom and its extension booms may also be called a boom subsystem.

Cranes having only one boom may also be called stiff boom cranes since they do not exhibit multiple booms that can change their orientation with respect to each other. In the event of cranes having multiple booms, a knuckle can be used to connect the different booms to one another so as to enable them to change their relative orientation, by bending or buckling about an axis defined by the knuckle.

In some examples, a crane may comprise a bendable boom system connected to the crane column. A bendable boom system may comprise a first boom, wherein a first end of the first boom is connected to the crane column. The bendable boom system may further comprise a second boom, wherein the second boom is connected to a second end of the first boom. Cranes having at least two booms connected by a knuckle or hinge offer an additional degree of freedom as compared to stiff boom cranes and may be called knuckle-boom cranes. The booms can be connected by hydraulic cylinders across the knuckle to cause the rotation.

The free end of the boom system not attached to the column may be referred to as the tip of the boom system. Loads may be directly attached to the tip of the boom system. However, cranes may additionally comprise at least one winch mounted to the boom system or elsewhere to the crane, the winch being used to wind und unwind a cable carrying the load. The tip of the boom system may exhibit a wheel for the cable. The cable extends to a load block used to attach the load thereto. In a single wire operation (also called STRAN1) the cable ends in the load block. The cable of the winch may also be used according to the principles of a pulley. If this is the case, the load block exhibits at least one pulley to change the direction of the cable and the cable ends at the boom system, typically close to the tip of the boom system. In the event of a single pulley, operation is also called two wire operation (STRAN2). Of course, multiple pulleys may be used likewise for multi wire operation.

Movement of the crane is caused by using multiple types of actuators such as hydraulic engines, valves and cylinders to cause motion of the booms and electric engines used to cause motion of the column or to operate the winch. Components used to cause movement of the crane or of parts of the crane are called actuators. The movement of the crane is monitored by means of multiple sensors, providing sensors readings indicative of multiple parameters or physical quantities. For example, pressure sensors may be used to monitor the pressure within hydraulic cylinders to determine the forces acting on them. Angle sensors may be used to monitor relative rotation or angle between different parts of the crane (e.g. between the column and the base or between different boom of a knuckle boom crane). Angle sensors may, for example use an encoder wheel together with a sensor sensitive to magnetic fields. Length sensors may be used to monitor the overall length of a boom and its associated extensions. Force sensors may be used to measure force directly or indirectly, for example to measure the force acting on the cable of a winch and/or on the winch itself. Force sensors may, for example, be based on the piezo electric effect or using strain gauges attached to the object being monitored.

The movement of the crane may be controlled by a crane controller that outputs control signals to cause the actuators of the crane to perform an operation. Likewise, the crane controller receives sensor readings to monitor the result of the actuators operation. In some examples, the crane controller may be an integral part of the crane. The desired movement of the crane is typically performed or controlled based on or following a user input. The user input may be manually given by a human operator or supervisor of the crane or it may likewise be generated automatically based on an algorithm or on input parameters generated by other means, such as for example by a trained neural network. For manual input, the crane may exhibit a crane mounted input device (operating panel) having, for example, one or more levers or joysticks to control motion as well as a user interface to input or change user settings and/or crane parameters such as for example different modes of operation of the crane. The input device communicates with the crane controller that transforms the user input into the actuator operations required to result with the desired movement as per the input via the input device. Additionally or alternatively, parts of or all inputs that can be performed using the input device may also be performed using a remote control unit wirelessly communicating with the crane controller.

A crane may be used for multiple purposes by providing the possibility to exchange equipment mounted at the booms of the crane. For example, multiple different attachments can be mounted to the booms close to the tip of the boom system. To support this, the crane may provide a mounting interface close to the tip of the crane. A mounting interface may be composed of multiple elements, mounted to or welded at a boom. Eventually, equipment such as a workmen basket may be mounted to the mounting interface via an adaptor used to adapt the (standard) mounting interface of the crane to a custom mounting interface of the equipment to be used.

In the illustration of FIG. 1, the illustrated crane 120 is a stiff boom crane. Control circuitry, winch arrangements and methods to operate a crane as disclosed herein may, however, likewise be used together with knuckle boom cranes.

The control circuitry for a crane 100 comprises an input interface 102 configured to receive readings of sensors sensing operating parameters of the crane.

For example, an angle sensor 174 may be used to monitor the elevation angle between the boom 130 and the column 160. The elevation angle is just an example for further or different boom angle parameters of a crane that may be used as sensor readings in other examples of control circuits 100. In this example, the elevation angle is a boom angle parameter determined based on an angle between a main boom 130 of the crane and the column 160. In further examples using knuckle boom cranes, the boom angle parameter may additionally or alternatively be determined based on an angle between a further boom and the main boom. Furthermore, another input represented by a length extension parameter measured by a boom extension sensor represents the present length of the boom 130 that depends on the extent the boom extensions 130a, 130b are driven out. The reading of a winch encoder configured to generate a sensor signal indicative of a cable length unrolled by the winch arrangement 140 may be used as a further sensor reading by the control circuitry 100. Another example is a pressure sensor that may be used to monitor the pressure within hydraulic cylinder 170 used to change the elevation angle of the boom 130.

An output interface 104 is configured to output control data to cause actuators of the crane to cause a motion of at least one of a boom of a boom system or a column of the crane. Actuators controlled may, for example, be hydraulic pumps or valves used to operate hydraulic cylinder 170 to change the elevation angle or to operate further hydraulics to cause the extension booms being driven out. Likewise, electric motors may be another type of actuators used to control the winding and unwinding of the cable of the winch arrangement or a rotation of the column 160.

The control circuit 100 further comprises a compute circuit 106 configured to control the operation of a winch arrangement 140 mounted to the boom 130 of the boom system such that a position of an attachment reference 150 of a cable of the winch arrangement 140 moves along a defined path during movement of the crane. An attachment reference 170 can be understood to be any position within the components of the winch arrangement 140 that is fixed relative to a load once a load is carried by the crane and attached to the winch arrangement 140. For example, the attachment reference may be given by the hook 150 illustrated in FIG. 1. Likewise, the attachment reference may be defined to be an arbitrary position at the load block supporting the hook 150, such as for example the center of a bolt serving as a bearing for a pulley within the load block.

Controlling the winch arrangement 140 such that the attachment reference 150 follows a defined path while other parts of the crane move avoids undesirable oscillating movements of an attached load or eventually even collisions between the attachment reference or the load and the tip of the boom 130.

The path that the attachment reference 150 follows once (or when) a crane is controlled by an example of a control circuit 100 can be arbitrary and optionally based on individual user input. FIGS. 2 and 3 illustrate two examples of paths that may be of particular use for an operator of a crane.

FIG. 2 schematically illustrates operating a crane such that a horizontal position of the attachment reference 150 moves within a determined deviation from horizontal. In other words, the determined path 210 is given such that the horizontal position of the attachment reference 150 is nearly constant. Nearly constant may be understood to mean that it's the desired goal to maintain the attachment reference constant while deviations coming from uncertainties in the sensor readings and from tolerances in operating the actuators are accepted. For example, the acceptable deviation from constant may be defined by the root mean square error of the path (with horizontal being the reference) being smaller than 5%, 3% or 1% of the initial distance of the attachment reference to ground. A horizontal path 210 may, for example, be beneficial if the extension booms of a boom are driven out for the purpose of increasing the distance between the column of the crane and the attachment reference 150/load.

FIG. 3 schematically illustrates operating a crane such that a distance between the attachment reference 150 and the tip 145 of the boom system is determined and constant. The term constant is understood to be as in the previous example illustrated in FIG. 2. To this end, the path can be understood to be such that a distance between the attachment reference 150 and a tip 145 of the boom system remains within a predetermined interval during movement of the crane. Path 310 may, for example, be beneficial if the extension booms of a boom are driven out for the purpose of increasing the height of the attachment reference 150/load.

The previous illustrations predominantly illustrate crane movements caused by a variation of the elevation angle and the length of the boom 130. Further examples of control circuitry may likewise consider the orientation of the platform the crane 120 is mounted to. Cranes may, for example, be mounted on mobile platforms, such as trucks, lorries or ships. Depending on the circumstances, those platforms and, hence, the crane 120 may not be deployed perfectly horizontal. This results in a vertical movement of the tip 145 of the crane once the column 160 is rotated about the slew angle. In order to also consider associated variations of the position of the attachment reference 150, further examples may also be configured to receive at least one of a sensor reading of a slew angle sensor indicating an angle of rotation of the column 160 of the crane 120 and/or a sensor reading of a platform tilt sensor indicating a tilting angle of the column 160. In this context, the tilting angle may be understood as a quantity indicative of the vector of the direction of the column. For example, the tilting angle may give the extent or angle the column 160 deviates from vertical.

Depending on the actuators of the crane and the winch arrangement used, the speeds in which the actuators can cause movement of the crane and the speeds in which the winch arrangement can wind or unwind cable may be different. It may be desirable to limit or adjust the speed of particular activators in order to result with the attachment reference 150 being able to follow the determined path while the crane moves.

For example, the speed of movement of the boom system may be adjusted based on a winding or unwinding speed of the winch arrangement 150. For example, hydraulic valves or pumps used to control movement of hydraulic cylinder 170 or the extension booms 130a and 130b may be operated such that the maximum achievable speed is limited in order to enable the actuator of the winch arrangement 140 to wind or unwind the cable fast enough. In those circumstances, the control circuitry 110 can still be understood as to execute an operation mode in which the operation of the winch arrangement is controlled such that the position of the attachment reference 150 follows a defined path while the crane 120 is moving. In said operation mode, at least one of a maximal speed and a minimum speed of the movement of the boom system may be adjusted based on a winding or unwinding speed of the winch arrangement. The movement of the crane 120 comprises a movement of at least one boom of a boom system or a rotation of the column.

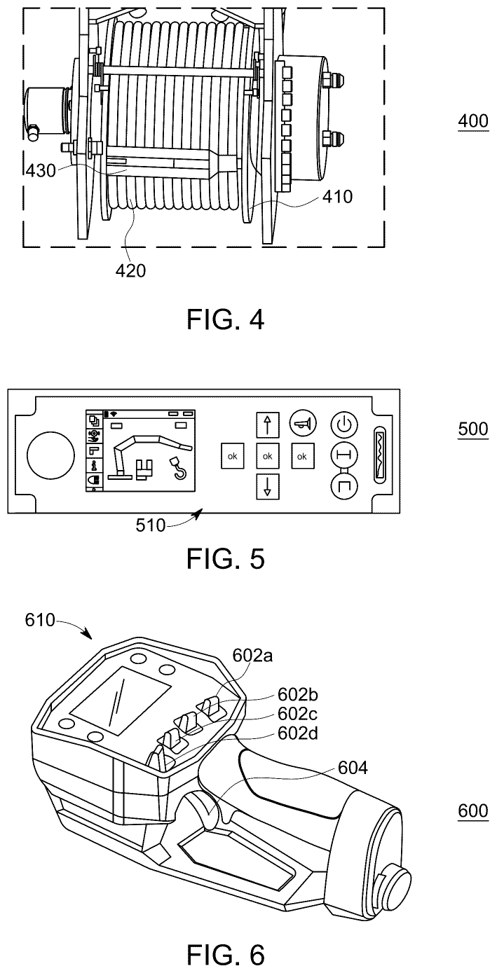

FIG. 4 illustrates an example of a winch arrangement 400 that may be used in the previously described examples.

The winch arrangement 400 comprises a rotatable drum 410 to wind the cable 420 to and a winch encoder to determine the length of the cable 420 unwound from the drum 410. The winch encoder may comprise a rotational or angle sensor (not illustrated) as well as means to determine the diameter (or the number of the layer of different layers of windings) the presently unwound piece of cable comes from. The means to determine the diameter 430 may, for example, be capable to determine which layer of the cable is presently unwound so that the winch encoder can combine the information of the outer diameter of the drum and the thickness of the cable, calculate the length of the cable unrolled by a full rotation of the drum 410. The winch encoder may incrementally count the rotation angle performed by the drum and so determine the absolute length of the cable unwound. In order to ensure that the cable 420 is wound on the drum 410 without undesired intersections, the winch arrangement 400 may exhibit a preloaded element 430 to exert force on the cable 420 in a radially inward direction towards a surface of the drum, the force preventing the cable 420 from winding and unwinding in an undesired manner. In order to guarantee said functionality, the pre-loaded element may extend more than 70%, 80% or 90% along an axial extension of the drum 410.

In other words, a spring and an axis push a lever and bush/drum on the cable in every layer on the drum of the winch arrangement. Such an arrangement may reduce unintentionally unwinding or sideward movement of the cable when not under tension from a load. Push element presses over complete length of drum to hold cable in position. So, no sideward movement of cable is possible. Further, so called bird nesting is prevented where the cable performs uncontrolled movement around the drum.

FIG. 5 illustrates an example of a control panel 500 usable to control operation of a crane or to set parameters and operation modes of the crane. The control panel 500 may be directly connected to the control circuit 100 in order to set operation modes or influence parameters controlled by the control circuit 100. The control panel 500 may be mounted directly on the crane or somewhere on a platform used to support the crane, such as for example at a truck or at a lorry. According to the examples described herein, control panel 500 comprises a user interface 510 configured to activate an operation mode of the crane in which the operation of the winch arrangement is controlled such that a position of an attachment reference follows a defined path while the crane is moving. Depending on the implementation, the user interface 510 may provide for the possibility to choose between different operation modes associated to different determine paths or to even allow the definition of a user defined determined path of the attachment reference.

Similarly, FIG. 6 illustrates an example of a remote control unit 600 usable to control operation of a crane. While the remote control unit 600 illustrated in FIG. 6 is a pistol grip controller for single-handed operation of a crane, further examples may likewise use another type of a controller, for example a controller using two joysticks to be operated simultaneously using two hands of an operator. The pistol grip remote control unit 600 exhibits multiple switches 602a-602d to select the actuator to be operated as well as a proportional controller 604 be operated with a single finger. The proportional controller 604 may, for example, serve to control the speed of the movement of an actuator selected by means of one of the switches 602a-602d. In a different mode of operation, the proportional controller may likewise serve as a dead man switch that needs to be kept pushed while the crane performs a user supervised semi-automatic sequence of movements.

The remote control unit further comprises a user interface 610 configured to activate an operation mode of the crane in which the operation of the winch arrangement is controlled such that a position of an attachment reference follows a defined path while the crane is moving.

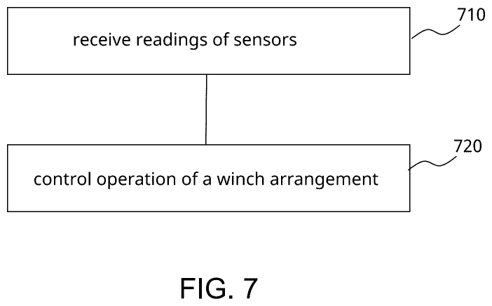

FIG. 7 illustrates a flowchart of an example of a method to operate a crane 700.

The method comprises receiving readings of sensors 710 sensing operating parameters of the crane and controlling operation of a winch arrangement 720 of the crane such that a position of an attachment reference at a cable wound and unwound by a winch arrangement follows a defined path while the crane is moving.

In other words, the previously described examples provide winch synchronization modes (SRC) to enable a smooth operation, especially with the one hand pistol grip (toggles), as it reduces correction movements of controller by the operator.

The SRC functionality can be used in one (STRAN1) or double line (STRAN2) operation mode. The activation of a SRC mode can be performed via a user interface on a console or on a remote control unit and is shown when active on the main screen via the graphic display. When SRC is active, manual rope operation is also possible by just moving the winch up/down lever/toggle, as while the winch movement is performed according to a chosen SRC Mode. SRC may also stay active when switching the crane ON/OFF and need to be actively deselected by the operator. In case the distance between the pulley head and the crane gets to close and/or would get into its end position the system keeps a minimum distance between boom and pulley head.

From monitoring and by sensor/encoder readings, the crane controller automatically corrects operation of the winch arrangement so that the rope winch follows the other crane movements to result with a determined path. For example, 2 modes may be provided.

### a) SRC Horizontal

SRC keeps the load on a constant height (the vehicle inclination is set to zero or the value of an optional inclination sensor is used for inclination correcture). When a crane function which has an impact on the height (main boom, extension boom, optional slewing) is driven, the winch moves simultaneously automatic with a velocity, which is set in a way that the load holds the total height. Additionally it could be possible that a desired velocity of main boom and/or extension boom, which is set by the operator on the remote control, has to be reduced. This reduction has to be done to ensure that the winch has even the possibility to compensate the difference in height.

### b) SRC Constant

SRC keeps the distance between pulley head and next vertical collision point of the crane (main boom, horsehead etc.) constant, when the main boom and/or extension boom are moving. As an example, the following sensor readings may be used:
Rotary encoder on the winch (for calculating the rope length and rope layer)
Length measurement system of the main boom extension
Rotary encoder between main boom and column.
Operation mode (1 or 2 Line Operation), which can be set manually OR automatically
Optional Inclination of the crane column
Proportional control valve with hydraulical or electrical flow-sharing
RRC Controller
Crane Controller

The controller circuit used to provide aid functionality increases operator friendliness by reducing correction movements to be performed manually.
SRC A keep the distance between pulley head and the ground horizontal constant
SRC B keep the distance between pulley head and the hook block (load block) constant.

Different SRC modes can be activated via the graphic user interface (display). Manual rope operation is also possible in parallel. SRC modes remain active when switching the crane on or off.

In the following, some examples of the proposed concept are presented:

An example (e.g., example 1) relates to control circuitry (110) for a crane (120), comprising an input interface (102) configured to receive readings of sensors sensing operating parameters of the crane (120), an output interface (104) to output control data to cause actuators of the crane (120) to cause a motion of at least one of a boom (130) of a boom system or a column (160) of the crane (120), and a compute circuit (106) configured to control the operation of a winch arrangement (140, 400) mounted to a boom (130) of the boom system, wherein a position of an attachment reference (150) of a cable (420) of the winch arrangement (140, 400) moves along a defined path during movement of the crane (120).

Another example (e.g., example 2) relates to a previous example (e.g., example 1) or to any other example, further comprising that the path (210, 310) is such that a horizontal position of the attachment reference (150) moves within a determined deviation from horizontal during movement of the crane (120).

Another example (e.g., example 3) relates to a previous example (e.g., example 1) or to any other example, further comprising that the path (210, 310) is such that a distance between the attachment reference (150) and a tip (145) of the boom system remains within a predetermined interval during movement of the crane (120).

Another example (e.g., example 4) relates to a previous example (e.g., one of the examples 1 to 3) or to any other example, further comprising that the input interface (102) is configured to receive a reading of a boom angle sensor indicating at least one boom (130) angle parameter of the crane (120), receive a reading of a winch encoder (430) configured to generate a sensor signal indicative of a cable length unrolled by the winch, and receive a reading of a boom extension sensor indicating a length extension parameter of the boom (130), wherein the compute circuit (106) is configured to control the operation of the winch based on the at least one boom (130) angle parameter, the sensor signal and the length extension parameter.

Another example (e.g., example 5) relates to a previous example (e.g., example 4) or to any other example, further comprising that the at least one boom (130) angle parameter is determined based on at least one of an angle between a main boom of the crane (120) and the column (160) or an angle between a further boom and the main boom.

Another example (e.g., example 6) relates to a previous example (e.g., one of the examples 4 or 5) or to any other example, further comprising that the input circuit is further configured to receive at least one of a sensor reading of a slew angle sensor indicating an angle of rotation of the column (160) of the crane (120) or a sensor reading of a platform tilt sensor indicating a tilting angle of the column (160).

Another example (e.g., example 7) relates to a previous example (e.g., one of the examples 1 to 6) or to any other example, further comprising that the control circuitry (100) is configured to control the movement of a crane (120) having a single boom (130) attached to the column (160).

Another example (e.g., example 8) relates to a previous example (e.g., one of the examples 1 to 7) or to any other example, further comprising that in the control circuitry (100) is configured to execute an operation mode, wherein the operation of the winch is controlled such that the position of the attachment reference (150) follows a defined path while the crane (120) is moving, wherein in the operation mode, the speed of movement of the boom system is adjusted based on a winding or unwinding speed of the winch arrangement (140, 400).

Another example (e.g., example 9) relates to a previous example (e.g., example 8) or to any other example, further comprising that in the operation mode, at least one of a maximal speed and minimum speed of the movement of the boom system is adjusted based on a winding or unwinding speed of the winch arrangement (140, 400).

Another example (e.g., example 10) relates to a previous example (e.g., one of the examples 1 to 9) or to any other example, further comprising that movement of the crane (120) comprises a movement of at least one boom (130) of the boom system.

Another example (e.g., example 11) relates to a previous example (e.g., one of the examples 1 to 9) or to any other example, further comprising that movement of the crane (120) comprises movement of at least one boom (130) of the boom system and rotation of the column (160).

An example (e.g., example 12) relates to a crane (120), comprising an extendible main boom (130) mounted on a rotatable column, a winch arrangement (140, 400) attached to the main boom to perform winding or unwinding of a cable (420) having attached thereto a load block, and control circuitry (100) according to any one of examples 1 to 7.

Another example (e.g., example 13) relates to a previous example (e.g., example 8) or to any other example, further comprising that the winch arrangement (140, 400) comprises a drum (410) for winding or unwinding the cable (420), and a pre-loaded element extending more than 80% along an axial extension of the drum (410), exerting force on the cable (420) in a radially inward direction towards a cylindrical surface of the drum (410).

Another example (e.g., example 14) relates to a previous example (e.g., one of the examples 8 or 9) or to any other example, further comprising a remote control unit (600) to wirelessly interact with the control circuitry (100) to cause the control circuitry (100) to activate actuators of the crane (120) based on an input indicative of a desired movement of the crane (120).

Another example (e.g., example 15) relates to a previous example (e.g., example 9) or to any other example, further comprising that the remote control unit (600) comprises a user interface (510, 610) configured to activate an operation mode of the crane (120) in which the operation of the winch arrangement (140, 400) is controlled such that a position of an attachment reference (150) follows a defined path while the crane (120) is moving.

An example (e.g., example 16) relates to a winch arrangement (140, 400) for a crane (120), comprising a drum (410) for winding or unwinding a cable (420), and a pre-loaded element extending more than 80% along an axial extension of the drum (410), exerting force on the cable (420) in a radially inward direction towards a cylindrical surface of the drum (410).

An example (e.g., example 17) relates to a remote control unit (600) to wirelessly interact with control circuitry (100) of a crane (120) to cause the control circuitry (100) to activate actuators of the crane (120), the remote control unit (600) comprising a user interface (510, 610) configured to activate a first operation mode of the crane (120) in which the operation of the winch arrangement (140, 400) is controlled such that a position of an attachment reference (150) of the crane (120) follows a defined path while the crane (120) is moving.

An example (e.g., example 18) relates to a method (700) to operate a crane (120), comprising receiving readings of sensors sensing operating parameters of the crane (120), controlling operation of a winch arrangement (140, 400) of the crane (120) such that a position of a an attachment reference (150) at a cable (420) coiled wound and unwound by the winch follows a defined path while the crane (120) is moving.

Another example (e.g., example 19) relates to a computer program having program code causing performing the method of example 13 if the program is executed by control circuitry (100) of a crane (120).

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. Control circuitry for a crane, comprising:
an input interface configured to receive readings of sensors sensing operating parameters of the crane;
an output interface to output control data to cause actuators of the crane to cause a motion of at least one of a boom of a boom system or a column of the crane; and
a compute circuit configured to control the operation of a winch arrangement mounted to the crane, wherein a position of an attachment reference of a cable of the winch arrangement moves along a defined path during movement of the crane.

2. Control circuitry according to claim 1, wherein the path is such that a horizontal position of the attachment reference moves within a determined deviation from horizontal during movement of the crane.

3. Control circuitry according to claim 1, wherein the path is such that a distance between the attachment reference and a tip region of a boom system of the crane remains within a predetermined interval during movement of the crane.

4. Control circuitry according to claim 1, wherein the
input interface is configured to
receive a reading of a boom angle sensor indicating at least one boom angle parameter of the crane;
receive a reading of a cable encoder configured to generate a sensor signal indicative of a cable length unrolled by the winch; and
receive a reading of a boom extension sensor indicating a length extension parameter of the boom, wherein
the compute circuit is configured to control the operation of the winch based on the at least one boom angle parameter, the sensor signal and the length extension parameter.

5. Control circuitry according to claim 4, wherein the at least one boom angle parameter is determined based on at least one of: an angle between a main boom of the crane and the column, and an angle between a further boom and the main boom.

6. Control circuitry according to claim 4, wherein the input circuit is further configured to receive at least one of: a sensor reading of a slew angle sensor indicating an angle of rotation of the column of the crane, and a sensor reading of a platform tilt sensor indicating a tilting angle of the column.

7. Control circuitry according to claim 1, wherein the control circuitry is configured to control the movement of a crane having a single boom attached to the column.

8. Control circuitry according to claim 1, wherein in the control circuitry is configured to execute an operation mode, wherein the operation of the winch is controlled such that the position of the attachment reference follows a defined path while the crane is moving,
wherein in the operation mode, the speed of movement of the boom system is adjusted based on a winding or unwinding speed of the winch arrangement or the winding or unwinding speed of the winch arrangement is adjusted based on the speed of movement of the boom system.

9. Control circuitry according to claim 8, wherein in the operation mode, at least one of a maximal speed and a minimum speed of the movement of the boom system is adjusted based on a winding or unwinding speed of the winch arrangement.

10. Control circuitry according to claim 1, wherein movement of the crane comprises a movement of at least one boom of the boom system.

11. Control circuitry according to claim 1, wherein movement of the crane comprises movement of at least one boom of the boom system and rotation of the column.

12. A crane arrangement, comprising:
an extendible main boom mounted on a rotatable column;
a winch arrangement attached to the crane to perform winding or unwinding of a cable having attached thereto a load block; and
control circuitry according to claim 1.

13. The crane of claim 12, wherein the winch arrangement comprises:
a drum for winding or unwinding the cable; and
a pre-loaded element extending more than 80% along an axial extension of the drum, exerting force on the cable in a radially inward direction towards a cylindrical surface of the drum.

14. The crane of claim 12, further comprising:
a remote control unit to wirelessly interact with the control circuitry to cause the control circuitry to activate actuators of the crane based on an input indicative of a desired movement of the crane.

15. The crane of claim 14, wherein the remote control unit comprises a user interface configured to activate an operation mode of the crane in which the operation of the winch arrangement is controlled such that a position of an attachment reference follows a defined path while the crane is moving.

16. A method to operate a crane, comprising:
receiving readings of sensors sensing operating parameters of the crane;
controlling operation of a winch arrangement of the crane such that a position of an attachment reference at a cable coiled wound and unwound by the winch follows a defined path while the crane is moving.
